(19) United States
(12) Patent Application Publication
(10) Pub. No.: US 2026/0152161 A1
(43) Pub. Date: Jun. 4, 2026

(54) AXLE BRAKE MODULE, BRAKE SYSTEM, MOTOR VEHICLE, VEHICLE TRAILER

(71) Applicant: Robert Bosch GmbH, Stuttgart (DE)

(72) Inventors: Bernd Lutz, Kempten (DE); Martin Winkler, Sonthofen (DE)

(21) Appl. No.: 19/398,383

(22) Filed: Nov. 24, 2025

(30) Foreign Application Priority Data
Dec. 2, 2024 (DE) 10 2024 211 501.0

(51) Int. Cl. B60T 13/68; B60T 8/17

(52) U.S. Cl. CPC B60T 13/686; B60T 8/1708

(57) ABSTRACT

An axle brake module of a brake system of a motor vehicle or of a vehicle trailer, having two actuatable wheel brake devices for decelerating the motor vehicle or the vehicle trailer. Each of the wheel brake devices being assignable/assigned to a different wheel of the same axle of the motor vehicle or of the vehicle trailer. The brake system includes a controllable brake force generator, the brake force generator being configured to pump hydraulic fluid into at least one hydraulic brake circuit in order to generate a brake pressure at the particular wheel brake device. The axle brake module has a common hydraulic brake circuit or two hydraulic brake circuits, each assigned to one of the wheel brake devices, in each case as a hydraulically closed brake circuit, such that it is assigned only to the axle brake module.

### FIELD

The present invention relates to an axle brake module of a brake system of a motor vehicle or of a vehicle trailer, having two, in particular precisely two, actuatable wheel brake devices for decelerating the motor vehicle or the vehicle trailer, each of the wheel brake devices in each case being assignable/assigned to a different wheel of the same axle of the motor vehicle or of the vehicle trailer, and having one, in particular precisely one, controllable brake force generator, the brake force generator being configured to pump hydraulic fluid into at least one hydraulic brake circuit in order to generate a brake pressure at the particular wheel brake device.

Moreover, the present invention relates to a brake system having such an axle brake module, and to a motor vehicle and a vehicle trailer, each having such a brake system.

### BACKGROUND INFORMATION

Axle brake modules of the aforementioned type are describes in the related art. For example, Germany Patent Application No. DE 10 2010 044 501 A1 describes a hydraulic brake system for a motor vehicle having at least four wheels, in which a dedicated brake is assigned to each wheel, a common electromechanical brake booster being assigned in each case to two of the brakes, separated into front axle and rear axle, which brake booster is in each case connected to a hydraulic control unit that is configured to supply the two respective brakes, independently of one another, with a hydraulic brake fluid provided by the brake booster for selective brake force distribution.

Germany Patent Application No. DE 101 18 263 A1 describes an electronic control system for a vehicle brake system, comprising a driver request module for recording a driver braking request and comprising at least two brake circuit modules for controlling the wheel brakes, in which at least one electrically controllable brake actuator is assigned to each brake circuit module, and an electronics unit for performing actuator-specific control functions and/or sensor-specific evaluation functions being assigned to each brake actuator. In particular, the actuators for controlling the wheel brakes are grouped together as axle modules. Each axle module comprises two brake actuators.

### SUMMARY

An axle brake module according to an example embodiment of the present invention has a common hydraulic brake circuit or two hydraulic brake circuits, each assigned to one of the wheel brake devices, in each case as a hydraulically closed brake circuit, such that it is assigned only to the axle brake module. With the configuration of the axle brake module according to the present invention, a separate, independent brake circuit is assigned to the corresponding axle of the motor vehicle. The axle brake module does not require an external hydraulic connection. If a plurality of axle brake modules are provided, in particular one for each axle of the motor vehicle, these are, in particular, merely electrically connected to a higher-level control logic for control purposes, but are not hydraulically connected to one another. This offers the advantage that the brake system can be built in modules and pre-assembled independently of the assembly of the vehicle. In particular, the conventional filling of a hydraulic vehicle-wide brake circuit is dispensed with, which otherwise can only be done after the brake system has been fully assembled, because the axle brake modules are hydraulically closed systems and are therefore advantageously filled in advance. In this respect, the axle brake module constitutes an advantageous alternative to the aforementioned, conventional axle brake modules, which, although they have at least one separate brake force generator per axle, do not explicitly form part of a separate hydraulically closed brake circuit, and in particular rely on a common brake fluid reservoir.

According to a preferred development of the present invention, the brake force generator has a controllable first actuator and a first hydraulic piston coupled to the actuator and displaceable in a brake cylinder, a first piston chamber, which is enclosed by the first hydraulic piston, being fluidically couplable/coupled to the first or a first of the hydraulic brake circuits. The use of such an actuator with hydraulic pistons provides an advantageous possibility to reliably supply the corresponding hydraulic brake circuit of the axle brake module with hydraulic fluid. The brake cylinder is then configured as a simple master brake cylinder.

Particularly preferably, the brake force generator has a second hydraulic piston that is spring-elastically coupled to the first hydraulic piston and is displaceable in the brake cylinder; a second piston chamber, which is enclosed by the second hydraulic piston, is fluidically couplable/coupled to a second of the hydraulic brake circuits; and each of the hydraulic brake circuits is assigned to another of the wheel brake devices. The use of two such coupled hydraulic pistons offers the advantage that each of the wheel brake devices is assignable/assigned its own hydraulic piston. The brake cylinder is then configured as a tandem master brake cylinder.

According to a preferred development of the present invention, the axle brake module has one, or in each case one, hydraulic pump in the or in the particular hydraulic brake circuit, the wheel brake devices being assigned the, or in each case one of the, hydraulic pumps. By using and assigning the or the particular hydraulic pump, an advantageous possibility is created to supply hydraulic fluid to the particular wheel brake device as required.

Particularly preferably, the axle brake module has at least one controllable second actuator, which is jointly assigned to the particular hydraulic pump or hydraulic pumps. With the second actuator, an advantageous possibility is created to precisely actuate the or the particular hydraulic pump in order to control a fluid quantity.

According to a preferred development of the present invention, the axle brake module has inlet valves and outlet valves in the or in the particular hydraulic brake circuit, each of the wheel brake devices being assigned one of the inlet valves and one of the outlet valves. With the inlet valves and outlet valves, an advantageous possibility is created to precisely control the hydraulic pressure at the particular wheel brake device.

Particularly preferably, the or the particular hydraulic pump is fluidically connectable/connected on the input side to the particular wheel brake device by the particular outlet valve.

The input-side connection of the hydraulic pump creates an advantageous possibility to easily reduce the hydraulic pressure as needed by controlling the hydraulic pump.

According to a preferred development of the present invention, the axle brake module has one, or in each case one, main switching valve in the or in the particular hydraulic brake circuit, the or the particular main switching valve being assigned to the particular piston chamber, through which main switching valve the hydraulic pump is fluidically connectable/connected on the input side to the particular piston chamber. With the main switching valve, an advantageous possibility is created to reliably separate the piston chamber from the brake circuit or connect it thereto.

The brake system of a motor vehicle or of a vehicle trailer having certain features of the present invention includes a first axle brake module configured according to the present invention that is assignable/assigned to an axle, in particular a first axle, of the motor vehicle or of the vehicle trailer. This results in the advantages already mentioned above.

According to an example embodiment of the present invention, particularly preferably, the brake system comprises a second axle brake module configured according to the present invention that is assignable/assigned to a further axle, in particular a second axle, of the motor vehicle or of the vehicle trailer and that is, in particular, configured differently from the first axle brake module. Using at least one second axle brake module results in the advantage that the brake system is constructed in an axle-wise modular manner from at least two hydraulic modules.

According to a preferred development of the present invention, the brake system comprises two electromechanical wheel brake modules that are assignable/assigned in each case to a different wheel of a further axle, in particular second or third axle, of the motor vehicle or of the vehicle trailer, and that are, in particular, of identical design, each having a controllable actuator for generating a braking force. By using two wheel brake modules, it is advantageously ensured that the brake system is constructed as a hybrid consisting of at least one hydraulic (wet) and two electromechanical (dry) modules.

Particularly preferably, the brake system has at least one control device that is specifically adapted to control the axle brake module or all brake modules, in particular axle brake module(s) and/or wheel brake modules, in a coordinating manner. Such a control device has the advantage that the brake system as a whole is controlled in a robust manner. If a plurality of modules are present, as described above, the control device ensures that the modules are controlled in a coordinated manner overall.

A motor vehicle having certain feature of the present invention includes the brake system according to the present invention. This also results in the advantages already mentioned above. In particular, the motor vehicle is part of a vehicle combination having at least one vehicle trailer. The vehicle trailer has, in particular, at least one further axle brake module according to the present invention.

The vehicle trailer having certain features of the present invention includes the brake system according to the present invention. This also results in the advantages already mentioned above.

Further preferred features and combinations of features result from what is disclosed herein. The present invention is explained in more detail below with reference to the figures.

### BRIEF DESCRIPTION OF THE DRAWINGS

FIG. 1 shows a first exemplary embodiment of an advantageous axle brake module, according to the present invention.

FIG. 2 shows a second exemplary embodiment of the axle brake module, according to the present invention.

FIG. 3 shows a third exemplary embodiment of the axle brake module, according to the present invention.

FIG. 4 shows a fourth exemplary embodiment of the axle brake module, according to the present invention.

FIG. 5 shows a motor vehicle or a vehicle trailer with at least one of the axle brake modules, according to an example embodiment of the present invention.

### DETAILED DESCRIPTION OF EXAMPLE EMBODIMENTS

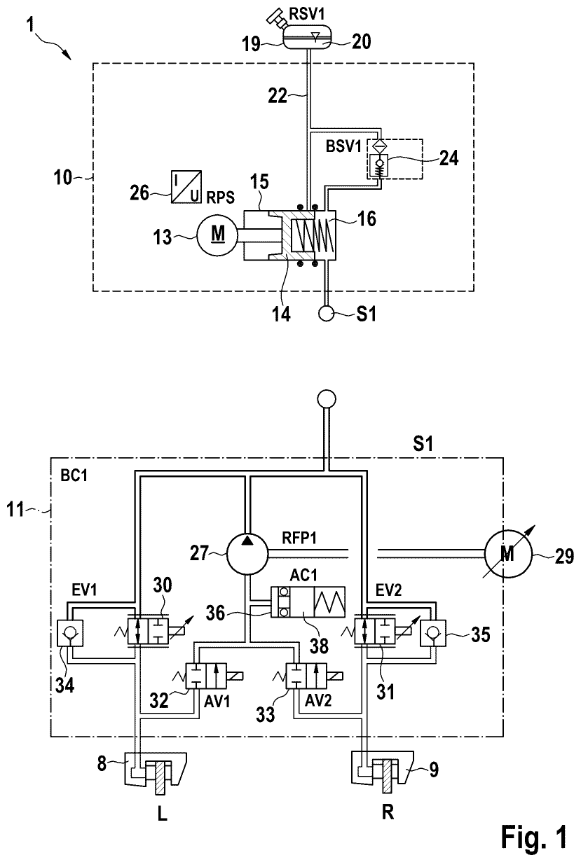

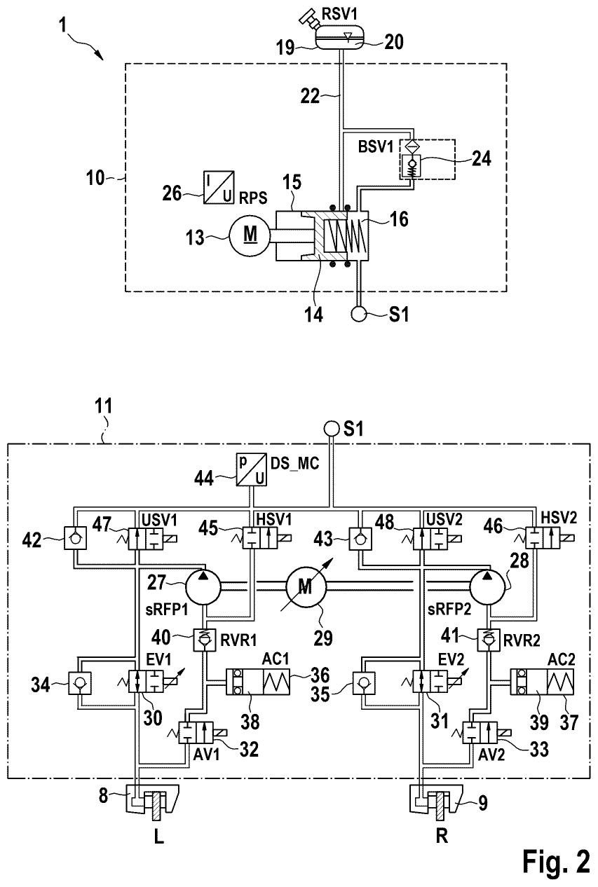

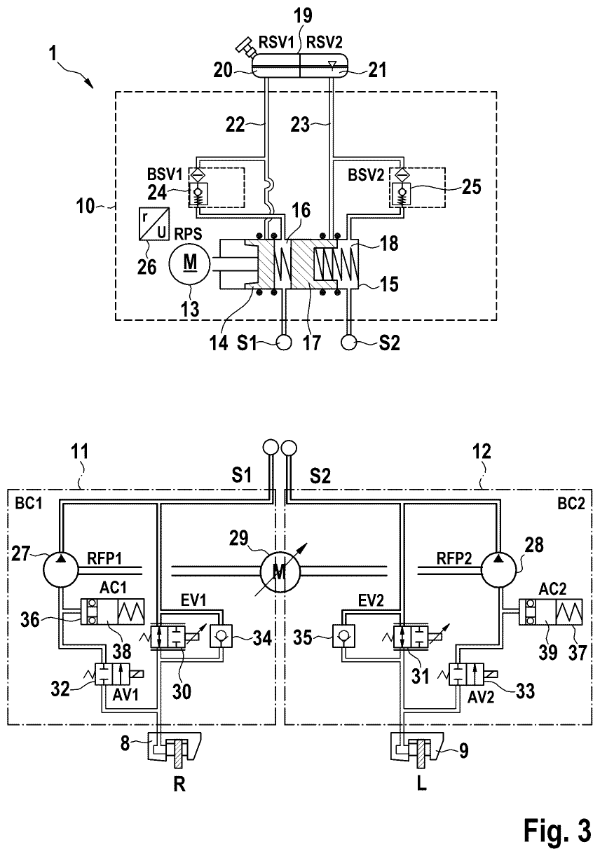

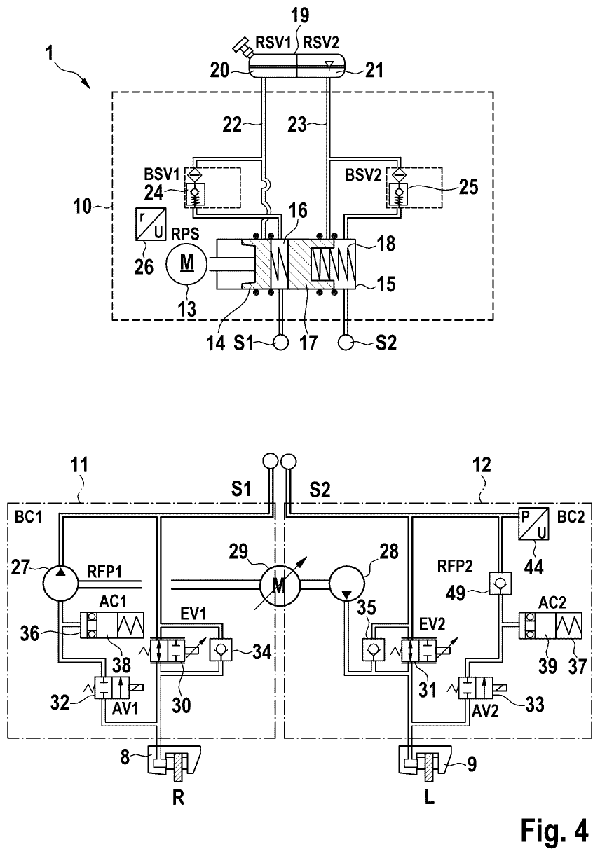

FIG. 1 to 4 each show different exemplary embodiments of advantageous axle brake modules 1 of the present invention. FIG. 1 shows a first exemplary embodiment, FIG. 2 a second exemplary embodiment, FIG. 3 a third exemplary embodiment and FIG. 4 a fourth exemplary embodiment of the axle brake module 1.

To the extent possible and appropriate, similar components are provided with the same reference sign and described together in the following. Differences will be pointed out where appropriate. The axle brake modules 1 are each part of a brake system 2 of a motor vehicle 3 or of a vehicle trailer 4.

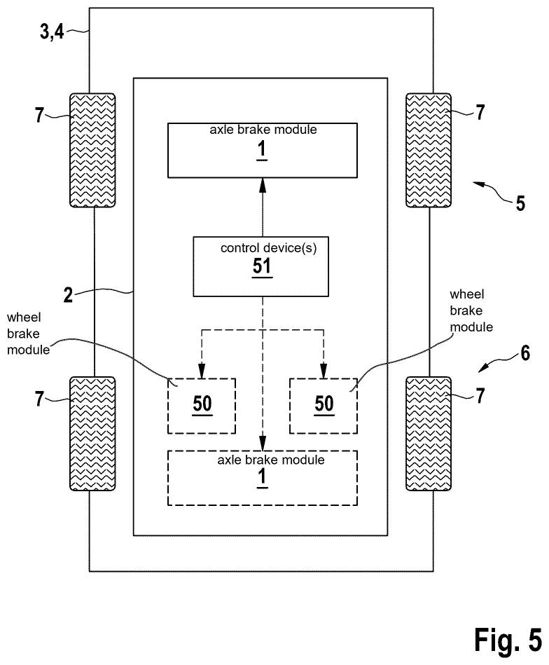

FIG. 5 shows an exemplary embodiment of the motor vehicle 3 or of the vehicle trailer 4, the motor vehicle 3 or the vehicle trailer 4 having the brake system 2 as well as a first axle 5, for example a front axle, and a second axle 6, for example a rear axle. The design having two axles 5, 6 is, however, merely exemplary; in particular, only one axle (in the case of a vehicle trailer) or a plurality of axles, for example an additional third axle, is provided (possible in the case of the motor vehicle 3 and the vehicle trailer 4). The particular axle 5, 6 has two wheels 7.

The axle brake module 1 has an actuatable first wheel brake device 8 and an actuatable second wheel brake device 9 for decelerating the motor vehicle 3 or the vehicle trailer 4. The wheel brake devices 8, 9 are designed in this case as conventional hydraulically actuatable friction brakes and, to this end, have at least two friction partners, in particular a brake lining and a brake disk. One of the friction partners, for example the brake lining, is mounted so as to be displaceable in the direction of the other friction partner, for example the brake disk.

Each of the wheel brake devices 8, 9 is in each case assignable, or, as indicated in FIG. 5, is assigned to another of the wheels 7 of the same axle 5, 6 of the motor vehicle 3 or of the vehicle trailer 4.

A special feature of the particular axle brake module 1 is that it only has the two wheel brake devices 8, 9, and the axle brake module 1 is otherwise hydraulically closed, i.e., it has no hydraulic connections to other wheel brake devices.

To this end, the particular axle brake module 1 also has a controllable brake force generator 10, in this case precisely one controllable brake force generator. The brake force generator 10 is configured to pump hydraulic fluid into at least one hydraulic brake circuit in order to generate a brake pressure at the particular wheel brake device 8, 9. In the present case, no mechanical through-actuation is provided, for example by means of a brake pedal that is actuatable by a driver. According to further exemplary embodiments not shown, such a mechanical through-actuation is provided.

In FIGS. 1 and 2, the axle brake module 1 has a hydraulic brake circuit 11 that is jointly assigned to the two wheel brake devices 8, 9. The hydraulic brake circuit 11 is configured as a hydraulically closed brake circuit, such that it is assigned only to the axle brake module 1.

In FIGS. 3 and 4, the axle brake module 1 has a first hydraulic brake circuit 11 that is assigned to the first wheel brake device 8 and a second hydraulic brake circuit 12 that is assigned to the second wheel brake device 9. The respective hydraulic brake circuits 11, 12 are in each case configured as a hydraulically closed brake circuit, such that each is assigned only to the axle brake module 1.

The brake force generator 10 has, in FIG. 1 to 4, a controllable first actuator 13 and a first hydraulic piston 14 coupled to the actuator 13. The actuator 13 is configured in the present case as an electric machine and is coupled to the hydraulic piston 14, for example, via a gear arrangement not shown in detail.

A rotor position sensor 26 for a rotor position of a rotor shaft of the electric machine is assigned to the actuator 13. The hydraulic piston 14 is arranged to be displaceable in a brake cylinder 15 and is spring-elastically preloaded on one side in the brake cylinder 15.

A first piston chamber 16, which is enclosed by the first hydraulic piston 14 within the brake cylinder 15, is fluidically couplable or coupled to the first hydraulic brake circuit 11. In the figures, the corresponding coupling is in each case indicated by a connection S1.

In FIGS. 3 and 4, the brake force generator 10 additionally has a second hydraulic piston 17 that is spring-elastically coupled to the first hydraulic piston 14. The second hydraulic piston 17 is also arranged to be displaceable in the brake cylinder 15 and is spring-elastically preloaded on the two sides in the brake cylinder 15.

A second piston chamber 18, which is enclosed by the second hydraulic piston 17, is fluidically couplable or coupled to the second hydraulic brake circuit 12. In the figures, the corresponding coupling is in each case indicated by a connection S2.

The particular axle brake module 1 also has a reservoir 19 for hydraulic fluid. The reservoir 19 has at least a first chamber 20, as well as, in FIGS. 3 and 4, an additional second chamber 21, the second chamber 21, in particular, being fluidically separated, at least in regions, from the first chamber 20, for example by a separating piece.

The reservoir 19 is fluidically connectable or connected to the particular piston chamber 16, 18 via at least one hydraulic line 22, 23. In each of the respective hydraulic lines 22, 23, a check valve 24, 25 is arranged.

Specifically, the first piston chamber 16 is connectable/connected to the first chamber 20 by a first hydraulic line 22 having a first check valve 24, and, in FIGS. 3 and 4, the second piston chamber 18 is connectable/connected to the second chamber 21 by a second hydraulic line 23 having a second check valve 25.

Furthermore, the axle brake module 1 has a first hydraulic pump 27 in the first hydraulic brake circuit 11, and, in FIG. 2 to 4, an additional second hydraulic pump 28 in the first hydraulic brake circuit 11 (FIG. 2) and in the second hydraulic brake circuit 12 (FIGS. 3 and 4).

In FIG. 1, the first hydraulic pump 27 is jointly assigned to the wheel brake devices 8, 9; in FIG. 2 to 4, the first hydraulic pump 27 is assigned to the first wheel brake device 8 and the second hydraulic pump 28 is assigned to the second wheel brake device 9.

In this case, the axle brake module 1 has at least one controllable second actuator 29 which is assigned to the first hydraulic pump 27 (FIG. 1) or jointly to the first and the second hydraulic pumps 27, 28 (FIG. 2 to 4). The actuator 29 is configured in the present case as an electric machine and is coupled to the hydraulic pump(s) 27, 28, for example, via a gear arrangement not shown in detail. In particular, a particular pump wheel of the particular hydraulic pump 27, 28 is connected, for conjoint rotation, to a rotor shaft of the machine.

Furthermore, the axle brake module 1 has two inlet valves 30, 31 and two outlet valves 32, 33. Each of the inlet valves 30, 31 is assigned a check valve 34, 35 which, in the present case, is hydraulically connected in parallel thereto. At least one of the inlet valves 30, 31 and one of the outlet valves 32, 33 is arranged in each of the hydraulic brake circuits 11, 12.

Each of the wheel brake devices 8, 9 is assigned precisely one of the inlet valves 30, 31 and one of the outlet valves 32, 33. The first wheel brake device 8 is in each case assigned a first inlet valve 30, which has a first check valve 34, and a first outlet valve 32, and the second wheel brake device 9 is in each case assigned a second inlet valve 31, which has a second check valve 35, and a second outlet valve 33.

The first inlet valve 30, which has the first check valve 34, and the first outlet valve 32 are each arranged in the first hydraulic brake circuit 11. The second inlet valve 31, which has the second check valve 35, and the second outlet valve 33 are accordingly arranged either also in the first hydraulic brake circuit 11 (FIGS. 1 and 2) or in the second hydraulic brake circuit 12 (FIGS. 3 and 4).

The hydraulic pumps 27, 28 each serve as return pumps for pumping excess hydraulic fluid, for example for modulating a hydraulic brake pressure, in particular after the end of a braking process, back to the particular piston chamber 16, 18 and finally into the particular chamber 20, 21 of the reservoir 19.

To this end, the or the particular hydraulic pump 27, 28 is fluidically connectable or connected on the input side to the particular wheel brake device 8, 9 by the particular outlet valve 32, 33.

Between the input side of the particular hydraulic pump 27, 28 and the particular outlet valve 32, 33, a cylinder 36, 37 having a spring-loaded piston 38, 39, which is displaceable therein, is also arranged in order to form an additional receiving space for hydraulic fluid as required. Thus, a first cylinder 36 having a first piston 38 is arranged on the input side of the first hydraulic pump 27, and, in FIG. 2 to 4, a second cylinder 37 having a second piston 39 is arranged on the input side of the second hydraulic pump 28.

In FIG. 2, a further check valve 40, 41 is arranged between the particular cylinder 36, 37 and the input side of the particular hydraulic pump 27, 28. Specifically, a further first check valve 40 is arranged between the first cylinder 36 and the first hydraulic pump 27, and a further second check valve 41 is arranged between the second cylinder 37 and the second hydraulic pump 28.

The particular hydraulic pump 27, 28 also has a further check valve 42, 43 assigned to its output side. Specifically, a further third check valve 42 is arranged on the output side of the first hydraulic pump 27, and a further fourth check valve 43 is arranged on the output side of the second hydraulic pump 28.

Furthermore, in the first hydraulic brake circuit 11 in FIG. 2, a pressure sensor 44 is arranged upstream of the respective hydraulic pumps 27, 28 and the check valves 42, 43. In FIG. 2, the axle brake module 1 also has a first and a second main switching valve 45, 46 and a first and a second changeover valve 47, 48 in the hydraulic brake circuit 11. The main switching valves 45, 46 and the changeover valves 47, 48 are assigned to the piston chamber 16.

The first hydraulic pump 27 is fluidically connectable or connected on the input side to the piston chamber 16 by the first main switching valve 45 which is arranged between the hydraulic pump 27 and the further first check valve 40. The second hydraulic pump 28 is fluidically connectable or connected on the input side to the piston chamber 16 by the second main switching valve 46 which is arranged between the hydraulic pump 28 and the further second check valve 41.

The first hydraulic pump 27 and the first inlet valve 30 are fluidically connectable or connected on the output side to the piston chamber 16 by the first switching valve 46. The second hydraulic pump 28 and the second inlet valve 31 are fluidically connectable or connected on the output side to the piston chamber 16 by the second switching valve 48.

In FIG. 4, the structure of the first hydraulic brake circuit 11 corresponds to that of FIG. 3. The structure of the second hydraulic brake circuit 12, however, has some special features. The arrangement of the second hydraulic pump 28 is modified such that both the second inlet valve 31, which has the second check valve 35, and the second outlet valve 33 are assigned on the output side to said hydraulic pump. The second hydraulic pump 28 is thereby selectively connectable or connected on the output side to the second piston chamber 18 by one of the aforementioned valves.

A check valve 49 is arranged between the second piston chamber 18 and the second piston 37 and the second outlet valve 33, and a pressure sensor 44 is arranged between the check valve 49 and the second piston chamber 18, analogously to FIG. 2.

In summary, the axle brake module 1 shown in FIG. 1 provides a single-channel anti-lock brake system (ABS), the axle brake module 1 shown in FIG. 2 provides an additional electronic stability control (ESP), the axle brake module 1 shown in FIG. 3 provides a dual-channel anti-lock brake system (ABS), and the axle brake module 1 shown in FIG. 4 provides a hybrid ABS and ESP functionality having an advantageously reduced number of components.

Finally, as mentioned at the outset, FIG. 5 schematically shows a motor vehicle 3 or a vehicle trailer 4. The brake system 2 installed therein has at least one of the axle brake modules 1 described above and shown in FIG. 1 to 4 on at least one of the axles 5, 6.

Due to their hydraulically closed design and limitation to precisely one axle, the axle brake modules 1 are part of an advantageous modular system for the brake system 2. For example, the brake system 2 has a first axle brake module 1 assigned to the first axle 5.

In addition, the brake system 2, as in each case indicated by dashed outlines, has, in particular, a second axle brake module 1 assigned to the second axle 6, or two electromechanical wheel brake modules 50 in each case assigned to one of the wheels 7 of the second axle 6.

The axle brake modules 1 can be configured identically or differently. The wheel brake modules 50 can also be configured identically or differently, and each has a controllable actuator for generating a braking force.

In order to control the corresponding brake modules 1, 50 in a coordinated manner, the brake system 2 finally has at least one control device 51 that is communicatively connectable or connected to the respective brake modules 1, 50.

1-14. (canceled)

15. An axle brake module of a brake system of a motor vehicle or of a vehicle trailer, the axle brake module comprising:
two actuatable wheel brake devices configured to decelerate the motor vehicle or the vehicle trailer, the wheel brake devices in each case being assignable/assigned to a different wheel of a same axle of the motor vehicle or of the vehicle trailer;
a controllable brake force generator, the brake force generator being configured to pump hydraulic fluid into at least one hydraulic brake circuit to generate a brake pressure at a particular one of the wheel brake devices;
wherein the axle brake module has: (i) a common hydraulic brake circuit assigned to the wheel brake devices as a hydraulically closed brake circuit or (ii) two hydraulic brake circuits, each assigned to one of the wheel brake devices, each of the two hydraulic brake circuits being a hydraulically closed brake circuit,
wherein the common hydraulic brake circuit or the two hydraulic brake circuits being assigned only to the axle brake module.

16. The axle brake module according to claim 15, wherein the axle brake module comprises precisely two actuable wheel brake devices and precisely one controllable brake force generator.

17. The axle brake module according to claim 15, wherein the brake force generator includes a controllable first actuator and a first hydraulic piston coupled to the actuator and displaceable in a brake cylinder, a first piston chamber, which is enclosed by the first hydraulic piston, being fluidically couplable/coupled to the common hydraulic brake circuit or a first of the two hydraulic brake circuits.

18. The axle brake module according to claim 17, wherein the brake force generator includes a second hydraulic piston that is spring-elastically coupled to the first hydraulic piston and is displaceable in the brake cylinder, a second piston chamber, which is enclosed by the second hydraulic piston, is fluidically couplable/coupled to a second of the two hydraulic brake circuits, and wherein each of the two hydraulic brake circuits is assigned to a different one of the two wheel brake devices.

19. The axle brake module according to claim 15, wherein the axle brake module includes at least one hydraulic pump in the common hydraulic brake circuit or in each of the two hydraulic brake circuits, the wheel brake devices being assigned the at least one hydraulic pump, or each of the wheel brake devices being assigned one of the hydraulic pumps.

20. The axle brake module according to claim 19, wherein the axle brake module includes at least one controllable second actuator that is jointly assigned to the at least one hydraulic pump or to the hydraulic pumps.

21. The axle brake module according to claim 15, wherein the axle brake module includes inlet valves and outlet valves in the common hydraulic brake circuit or in the two hydraulic brake circuits, each of the wheel brake devices being assigned one of the inlet valves and one of the outlet valves.

22. The axle brake module according to claim 19, wherein the axle brake module includes at least one hydraulic pump in the common hydraulic brake circuit or in each of the two hydraulic brake circuits, the wheel brake devices being assigned the at least one hydraulic pump, or each of the wheel brake devices being assigned one of the hydraulic pumps, and wherein each hydraulic pump is fluidically connectable/connected on an input side to a wheel brake device of the wheel brake devices by the outlet valve assigned to the wheel brake device.

23. The axle brake module according to claim 18, wherein the axle brake module includes at least one hydraulic pump in the common hydraulic brake circuit or in each of the two hydraulic brake circuits, the wheel brake devices being assigned the at least one hydraulic pump, or each of the wheel brake devices being assigned one of the hydraulic pumps, and wherein the axle brake module includes at least one main switching valve in the common hydraulic brake circuit or in each of the two hydraulic brake circuits, the at least one main switching valve fluidly connecting the at least one hydraulic pump or the hydraulic pumps to an input side of the first and/or second piston chamber.

24. A brake system of a motor vehicle or of a vehicle trailer, comprising:
a first axle brake module assigned to a first, axle of the motor vehicle or of the vehicle trailer, wherein the first axle brake module includes:
two actuatable wheel brake devices configured to decelerate the motor vehicle or the vehicle trailer, the wheel brake devices in each case being assigned to a different wheel of the first axle of the motor vehicle or of the vehicle trailer;
a controllable brake force generator, the brake force generator being configured to pump hydraulic fluid into at least one hydraulic brake circuit to generate a brake pressure at a particular one of the wheel brake devices;
wherein the axle brake module has: (i) a common hydraulic brake circuit assigned to the wheel brake devices as a hydraulically closed brake circuit or (ii) two hydraulic brake circuits, each assigned to one of the wheel brake devices, each of the two hydraulic brake circuits being a hydraulically closed brake circuit,
wherein the common hydraulic brake circuit or the two hydraulic brake circuits being assigned only to the first axle brake module.

25. The brake system according to claim 24, further comprising a second axle brake module assigned to a second axle of the motor vehicle or of the vehicle trailer, the second axle brake module being configured differently from the first axle brake module.

26. The brake system according to claim 24, further comprising a second axle brake module assigned to a second axle of the motor vehicle or of the vehicle trailer, the second axle brake module including:
two actuatable second wheel brake devices configured to decelerate the motor vehicle or the vehicle trailer, the second wheel brake devices in each case being assigned to a different wheel of the second axle of the motor vehicle or of the vehicle trailer;
a controllable second brake force generator, the second brake force generator being configured to pump hydraulic fluid into at least one hydraulic brake circuit to generate a brake pressure at a particular one of the wheel brake devices;
wherein the second axle brake module has: (i) a second common hydraulic brake circuit assigned to the second wheel brake devices as a hydraulically closed brake circuit or (ii) two second hydraulic brake circuits, each assigned to one of the second wheel brake devices, each of the two second hydraulic brake circuits being a hydraulically closed brake circuit,
wherein the second common hydraulic brake circuit or the two second hydraulic brake circuits being assigned only to the second axle brake module.

27. The brake system according to claim 24, further comprising two electromechanical wheel brake modules that are each assigned to a different wheel of a second or third axle of the motor vehicle or of the vehicle trailer, and that are of identical configuration, each having a controllable actuator for generating a braking force.

28. The brake system according to claim 24, further comprising at least one control device that is specifically adapted to control the first axle brake module.

29. A motor vehicle, comprising:
a brake system including:
a first axle brake module assigned to a first, axle of the motor vehicle, wherein the first axle brake module includes:
two actuatable wheel brake devices configured to decelerate the motor vehicle, the wheel brake devices in each case being assigned to a different wheel of the first axle of the motor vehicle;
a controllable brake force generator, the brake force generator being configured to pump hydraulic fluid into at least one hydraulic brake circuit to generate a brake pressure at a particular one of the wheel brake devices;
wherein the axle brake module has: (i) a common hydraulic brake circuit assigned to the wheel brake devices as a hydraulically closed brake circuit or (ii) two hydraulic brake circuits, each assigned to one of the wheel brake devices, each of the two hydraulic brake circuits being a hydraulically closed brake circuit,
wherein the common hydraulic brake circuit or the two hydraulic brake circuits being assigned only to the first axle brake module.

30. A vehicle trailer, comprising:
a brake system including:
a first axle brake module assigned to a first, axle of the vehicle trailer, wherein the first axle brake module includes:
two actuatable wheel brake devices configured to decelerate the vehicle trailer, the wheel brake devices in each case being assigned to a different wheel of the first axle of the vehicle trailer;
a controllable brake force generator, the brake force generator being configured to pump hydraulic fluid into at least one hydraulic brake circuit to generate a brake pressure at a particular one of the wheel brake devices;
wherein the axle brake module has: (i) a common hydraulic brake circuit assigned to the wheel brake devices as a hydraulically closed brake circuit or (ii) two hydraulic brake circuits, each assigned to one of the wheel brake devices, each of the two hydraulic brake circuits being a hydraulically closed brake circuit,
wherein the common hydraulic brake circuit or the two hydraulic brake circuits being assigned only to the first axle brake module.
